(19) United States
(12) Patent Application Publication
(10) Pub. No.: US 2008/0059588 A1
(43) Pub. Date: Mar. 6, 2008

(54) Method and System for Providing Notification of Nefarious Remote Control of a Data Processing System

(76) Inventors: Emily J. Ratliff, Austin, TX (US); Loulwa F. Salem, Austin, TX (US); Kimberly D. Simon, Pflugerville, TX (US)

Correspondence Address: DILLON & YUDELL LLP, 8911 N. CAPITAL OF TEXAS HWY.,, SUITE 2110, AUSTIN, TX, 78759, US

(21) Appl. No.: 11/469,535

(22) Filed: Sep. 1, 2006

(51) Int. Cl. G06F 15/16; G06F 15/173

(52) U.S. Cl. 709/206; 709/224

(57) ABSTRACT

A system, method and computer program product for providing notification of nefarious remote control of a data processing system are disclosed. The method includes, in response to determining that a received email message contains an item of spam content, noting a source of the received email message to a harm database to increment a harm counter and, in response to determining that the harm counter has exceeded a harm threshold, notifying a designated administrator for said source.

### BACKGROUND OF THE INVENTION

1. Technical Field

The present invention relates in general to data processing systems and in particular to processing messages. Still more particularly, the present invention relates to a system, method and computer program product for providing notice of nefarious remote control of a data processing system.

2. Description of the Related Art

A zombie computer, commonly referred to simply as a ‘zombie’ is a computer attached to the Internet that has been compromised by a security cracker, a computer virus, or a trojan horse. Generally, a compromised machine is only one of many in a “botnet”, and the zombie will be used to perform malicious tasks of one sort or another under remote direction. Most owners of zombie computers are unaware that their system is being used in this way. Because the victim to be unconscious, these computers are metaphorically compared to a zombie.

Botnet is a jargon term for a collection of software robots, or zombies, which run autonomously. This can also refer to the network of computers using distributed computing software. While the term “botnet” can be used to refer to any group of bots, such as IRC bots, the word is generally used to refer to a collection of compromised machines running programs, usually referred to as worms, Trojan horses, or backdoors, under a common command and control infrastructure. A botnet's originator can control the group remotely, usually through a means such as IRC, and usually for nefarious purposes. Individual programs manifest as IRC “bots”. Often, the command and control takes place via an IRC server or a specific channel on a public IRC network. A zombie typically runs as a hidden process, and complies with the RFC 1459 (IRC) standard. Generally, the perpetrator of the botnet has compromised a series of systems using various tools (exploits, buffer overflows, as well as others; see also RPC). Newer bots can automatically scan their environment and propagate themselves using vulnerabilities and weak passwords. Generally, the more vulnerabilities a zombie can scan and propagate through, the more valuable it becomes to a botnet controller community.

Botnets have become a significant part of the Internet, albeit increasingly hidden. Due to most conventional IRC networks taking measures and blocking access to previously-hosted botnets, controllers must now find their own servers. Often, a botnet will include a variety of connections, ranging from dial-up, ADSL and cable, and a variety of network types, including educational, corporate, government and even military networks. Sometimes, a controller will hide an IRC server installation on an educational or corporate site, where high-speed connections can support a large number of other bots. Exploitation of this method of using a bot to host other bots has proliferated only recently, as most script kiddies do not have the knowledge to take advantage of it.

Several botnets have been found and removed from the Internet. The Dutch police found a 1.5 million node botnet and the Norwegian ISP Telenor disbanded a 10,000 node botnet. Large coordinated international efforts to shutdown botnets have also been initiated.

Botnet servers will often liaise with other botnet servers, such that a group may contain 20 or more individual cracked high-speed connected machines as servers, linked together for purposes of greater redundancy. Actual botnet communities usually consist of one or several controllers who consider themselves as having legitimate access (note the irony) to a group of bots. Such controllers rarely have highly-developed command hierarchies between themselves; they rely on individual friend-to-friend relationships. Often conflicts will occur between the controllers as to who gets the individual rights to which machines, and what sorts of actions they may or may not permit.

Botnets serve various purposes, including denial-of-service attacks, creation or misuse of SMTP mail relays for spam, click fraud, and the theft of application serial numbers, login IDs, and financial information such as credit card numbers. The botnet controller community features a constant and continuous struggle over who has the most bots, the highest overall bandwidth, and the largest amount of “high-quality” infected machines, like university, corporate, and even government machines.

Zombies have been used extensively to send e-mail spain; between 50% and 80% of all spam worldwide is now sent by zombie computers. This allows spammers to avoid detection and presumably reduces their bandwidth costs, since the owners of zombies pay for their own bandwidth.

For similar reasons zombies are also used to commit click fraud against sites displaying pay per click advertising. Zombies have also conducted distributed denial of service attacks, such as the attack upon the SPEWS service in 2003. In 2002, several prominent Web sites (Yahoo, eBay, etc) were clogged to a standstill by a distributed denial of service attack mounted by a Canadian teenager.

Unfortunately, all existing solutions for zombies are inadequate. What is needed is a method, system and computer program product for providing notification of nefarious remote control of a data processing system.

### SUMMARY OF THE INVENTION

A system, method and computer program product for providing notification of nefarious remote control of a data processing system are disclosed. The method includes, in response to determining that a received email message contains an item of spam content, noting a source of the received email message to a harm database to increment a harm counter and, in response to determining that the harm counter has exceeded a harm threshold, notifying a designated administrator of the source.

### BRIEF DESCRIPTION OF THE DRAWINGS

The novel features believed characteristic of the invention are set forth in the appended claims. The invention itself, however, as well as a preferred mode of use, further objects and advantages thereof, will best be understood by reference to the following detailed descriptions of an illustrative embodiment when read in conjunction with the accompanying drawings, wherein:

FIG. 1 depicts a block diagram of a general-purpose data processing system network with which the present invention of a system, method and computer program product for providing notification of nefarious remote control of a data processing system may be performed; and

FIG. 2 is a high-level logical flowchart of a process for providing notification of nefarious remote control of a data processing system in accordance with a preferred embodiment of the present invention.

### DETAILED DESCRIPTION OF THE PREFERRED EMBODIMENT

The present invention provides a method, system, and computer program product for providing notification of nefarious remote control of a data processing system.

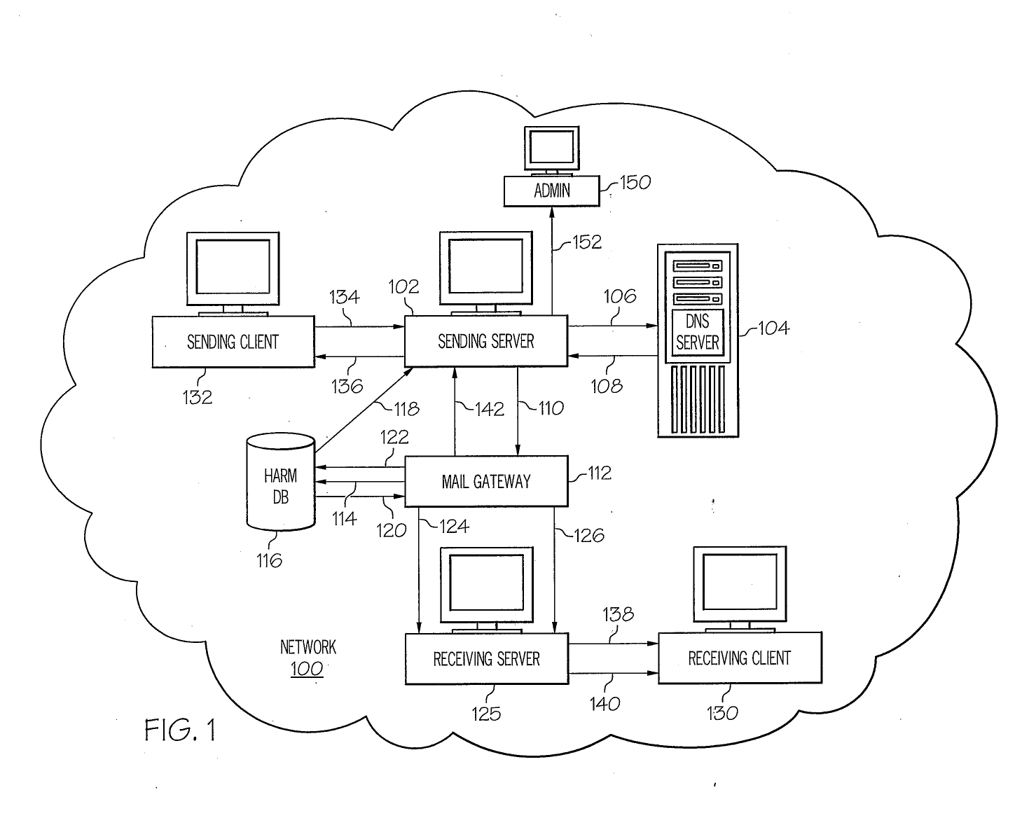

Referring now to the figures, and in particular to FIG. 1, a block diagram of a general-purpose data processing system network with which the present invention of a system, method and computer program product for providing notification of nefarious remote control of a data processing system may be performed. Network 100 represents a general-purpose network, such as the Internet. A sending mail server 102, a DNS server 104, a harm database 116, a mail gateway 112, a sending client 132, a receiving client 130 and a receiving mail server 128 reside on network 100.

DNS server 104 stores and associates many types of information with domain names, but most importantly, DNS server 104 translates domain names (computer hostnames) to IP addresses. DNS server 104 also lists mail exchange servers, such as mail gateway 112, accepting e-mail for each domain. In providing a worldwide keyword-based redirection service, DNS server 104 is a useful component of contemporary Internet use. Helpful for several reasons, DNS server 104 pre-eminently makes it possible to attach easy-to-remember domain names to hard-to-remember IP addresses. Humans take advantage of this substitution when they recite URLs and e-mail addresses. In a subsidiary function, the DNS server 104 makes it possible for people to assign authoritative names without needing to communicate with a central registrar each time.

Mail gateway 112 is a mail transfer agent or MTA (also called a mail transport agent, mail server, or a mail exchange server in the context of the Domain Name System), which is a computer program or software agent that transfers electronic mail messages from one computer to another. Mail gateway 112 receives messages from another MTA (relaying), a mail submission agent (MSA) such as sending server 102, that itself received the mail from a mail user agent (MUA), or directly from an MUA, thus acting as an MSA itself. Mail gateway 112 is generally invisible to a user of sending client 132 or receiving client 120, while the user usually interacts with the MUA. The delivery of e-mail to a user's mailbox typically takes place via a mail delivery agent (MDA); many MTAs have basic MDA functionality built in, but a dedicated MDA like procmail can provide more sophistication.

Sending mail server 102, in a preferred embodiment, implements SMTP, though those skilled in the art will quickly realize that the present invention is equally applicable to other protocols without departing from the scope of the present invention. Sending mail server 102 implements SMTP as a relatively simple, text-based protocol, where one or more recipients of a message are specified (and in most cases verified to exist) and then the message text is transferred. It is quite easy to test an SMTP server using the telnet program (see below).

In a preferred embodiment, ending mail server 102 uses TCP port 25. To determine the SMTP server for a given domain name, the MX (Mail eXchange) DNS record is used, falling back to a simple A record in the case of no MX. There are at least 50 available programs that implement SMTP as a client (sender of messages) or a server (receiver of messages). Some other popular SMTP server programs include exim, Postfix, qmail, and Microsoft Exchange Server. Since this protocol started out as purely ASCII text-based, it did not deal well with binary files. Standards such as MIME were developed to encode binary files for transfer through SMTP. MTAs developed after sendmail also tended to be implemented 8-bit-clean, so that the alternate “just send eight” strategy could be used to transmit arbitrary data via SMTP. Non-8-bit-clean MTAS today tend to support the 8BITMIME extension, permitting binary files to be transmitted almost as easily as plain text.

Receiving server 128 performs functions in accordance with the POP3 protocol. The design of POP3 and its predecessors supports end users with intermittent connections (such as dial-up connections), allowing these users to retrieve e-mail when connected and then to view and manipulate the retrieved messages without needing to stay connected. Although most clients have an option to leave mail on server, e-mail clients using POP3 generally connect, retrieve all messages, store them on receiving client 130 as new messages, delete them from the server, and then disconnect. In contrast, the newer, more capable Internet Message Access Protocol (IMAP) supports both connected and disconnected modes of operation. E-mail clients using IMAP generally leave messages on the server until the user explicitly deletes them. This and other facets of IMAP operation allow multiple clients to access the same mailbox. Most e-mail clients support either POP3 or IMAP to retrieve messages; however, fewer Internet Service Providers (ISPs) support IMAP. The fundamental difference between POP3 and IMAP4 is that POP3 offers access to a mail drop; the mail exists on the server until it is collected by the client. Even if the client leaves some or all messages on the server, the client's message store is considered authoritative. In contrast, IMAP4 offers access to the mail store; the client may store local copies of the messages, but these are considered to be a temporary cache; the server's store is authoritative.

The present invention operates through the transmission and receipt of a series of digital messages, which are transmitted over network 100 between two or more of sending mail server 102, DNS server 104, harm database 116, mail gateway 112, and receiving mail server 128. Sending client 132 transmits to sending server 102 a mail content message 134, containing a message to be sent out to receiving client 130. Sending server 102 then sends a DNS request 106, to resolve an IP address from the domain name of receiving server 128 to DNS server 104. DNS server 104 then sends a reply message 108, containing the IP address of receiving server 128, to sending server 102. Sending server 110 then sends a mail transmission message 110 to mail gateway 112.

Upon receipt of mail transmission message 110, mail gateway 112 performs a virus scan and a spam screening. If mail gateway 112 detects a virus, then mail gateway 112 sends a virus log request 122 to harm database 116, sends a notice of virus attempt 124 to receiving server 128, and sends a virus alert 142 to sending server 102, which sends a virus notice 136 to sending client 132. Upon receipt of a notice of virus attempt 124, receiving server 128 sends a notice of virus interdiction 138 to receiving client 130. Upon receipt of virus log request 122, harm database sends an acknowledgement 120 to email gateway 112.

If mail gateway 112 detects spam content, then mail gateway 112 sends a spam log request 114 to harm database 116. Upon receipt of spam log request 114, harm database sends an acknowledgement 120 to email gateway 112. Harm database 116 then determines whether a harm threshold has been exceeded. If harm database 116 determines that a harm threshold has been exceeded, then harm database 116 sends a zombie warning 118 to sending server 102, notifying an a designated administrator of sending server 102 that a large volume of spam is coming from sending server 102 and that sending server 102 or a client of sending server 102, such as sending client 132, may be the victim of a zombie attack. Sending server 102 then sends a zombie action request 152 to an administrator machine 150. In a preferred embodiment, administrator machine 150 is a machine designed by a desugnated administrator of sending client 132 to receive zombie action request 152. Because zombie action request 152 provides value to the users of both sending server 102 and sending client 132, users of either of sending server 102 and sending client 132 will bne incentivized to designated administrator machine 150 (with a corresponding electronic message account) and to pay a subscription fee for the monitoring of zombie warning 118 and delivery of a zombie action request 152. In a preferred embodiment, an owner of sending server 102 will collect a fee for sending zombie action request 152. In an alternative embodiment, an owner of harm database 116 will collect a fee for sending zombie warning 118. Harm database 116 then sends an acknowledgement 120 containing a ‘block request’ to email gateway 112, requesting that email gateway 112 block future email from sending server 102. Email gateway 112 forwards marked span 126 to receiving server 128, which forwards marked spam receiving client 130.

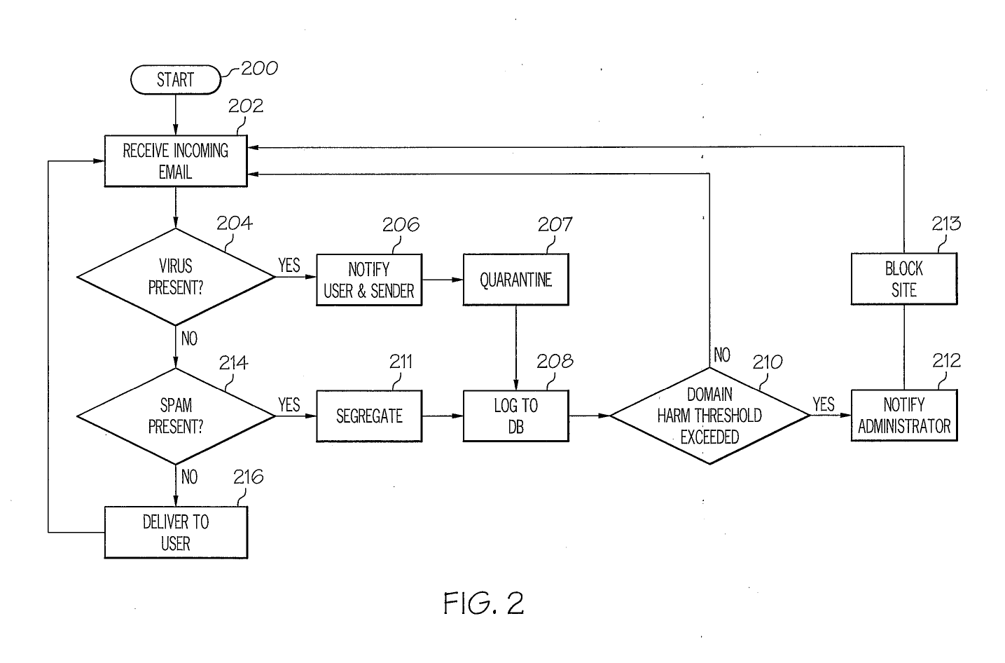

Turning now to FIG. 2, a high-level logical flowchart of a process for providing notification of nefarious remote control of a data processing system in accordance with a preferred embodiment of the present invention is depicted. The process starts at step 200 and then moves to step 202, which illustrates mail gateway 112 receiving mail transmission message 110. The process next proceeds to step 204, which depicts mail gateway 112 determining whether a virus is present in mail transmission message 110. If mail gateway 112 determines that a virus is present in mail transmission message 110, then the process moves to step 206. Step 206 illustrates mail gateway 112 sending notification of the presence of virus content in mail transmission message 110 by harm database 116, sending a notice of virus attempt 124 to receiving server 128 and sending a virus alert 142 to sending server 102. The process next moves to step 207, which illustrates mail gateway 112 quarantining mail transmission message 110 due to the presence of virus content. The process then proceeds to step 208. Step 208 illustrates harm database 116 logging the presence of virus or spam content by incrementing a harm counter for sending server 102.

The process then moves to step 210, which depicts harm database 116 determining whether a harm threshold for a harm counter representing sending server 102 has been exceeded. If harm database 116 determines that the harm threshold for the harm counter representing sending server 102 has not been exceeded, then the process returns to step 202, which is described above. However, if harm database 116 determines that the harm threshold for the harm counter representing sending server 102 has been exceeded, then the process then proceeds to step 212. Step 212 illustrates notification of a virus or spam by mail gateway 112 sending a virus alert 142 to sending server 102 or harm database 116 sending a zombie warning 118 to sending server 102.

Sending server 102 than sends a zombie action request 152 to administrator machine 150. In a preferred embodiment, administrator machine 150 is a machine designated by a designated adminstrator of sending client 132 to rceive zombie action request 152. Because zombie action request 152 provide value to the users of both sending server 102 and sending client 132, users of either of sending server 102 and sending client 132 will be incentivized to designate an adminstrator machine 150 (with a corresponding electronic message account) and to pay a subscription fee for the monitoring of zombie warning 118 and delivery of a zombie action request 152. In a preferred embodiment, an owner of sending server 102 will collect a fee for sending zombie action request 152. In an alternative embodiment, an owner of harm database 116 will collecrt a fee fro sending zombie warning 118. The process next moves to step 213, which illustrates harm database 116 sending an acknowledgement 120 containing a ‘a block request’ to email gateway 112, requesting that email gateway 112 block future email from sending server 102. The process then retures to step 202, which is described above.

Returning to step 204, if mail gateway 112 does not determine that a virus is present in mail transmission message 110, then the process moves to step 214, which illustrates mail gateway 112 determining whether spam content is present in mail transmission message 110. If mail gateway 112 determines that spam is present in mail transmission message 110, then the process moves to step 211. Step 211 illustrates mail gateway 112 segregating the content of mail transmission message 110 for delivery as marked spam 126 to receiving server 128, which forwards marked spam to receiving client 130. The process next proceeds to step 208, which is described above.

Returning to step 214, if mail gateway 112 does not determine that spam content is present in mail transmission message 110, then the process moves to step 216, which illustrates mail gateway 112 delivering the content of mail transmission message 110 to a user of receiving client 130.

While the invention has been particularly shown as described with reference to a preferred embodiment, it will be understood by those skilled in the art that various changes in form and detail may be made therein without departing from the spirit and scope of the invention. It is also important to note that although the present invention has been described in the context of a fully functional computer system, those skilled in the art will appreciate that the mechanisms of the present invention are capable of being distributed as a program product in a variety of forms, and that the present invention applies equally regardless of the particular type of signal bearing media utilized to actually carry out the distribution. Examples of signal bearing media include, without limitation, recordable type media such as floppy disks or CD ROMs and transmission type media such as analog or digital communication links.

What is claimed is:

1. A method for providing notice of nefarious remote control of a data processing system, said method comprising:
in response to determining that a received email message contains an item of spam content, noting a source of said received email message to a harm database to increment a harm counter; and
in response to determining that said harm counter has exceeded a harm threshold, notifying a designated administrator for said source.

2. The method of claim 1, wherein said method further comprises, in response to determining that said received email message contains an item of virus content;
noting said source of said received email message to said harm database to increment said harm counter;
performing a quarantine of said received email message;
sending a notice of a virus attack to a sender of said received email message; and
sending said notice of said virus attack to an intended recipient of said received email message.

3. The method of claim 1, wherein said method further comprises, in response to determining that said received email message contains said item of spam content, segregating said received email message.

4. The method of claim 1, wherein said method further comprises receiving said received email message.

5. The method of claim 1, wherein said method further comprises, in response to determining that said received email message does not contain said item of spam content and does not contain said item of virus content, delivering said message to an intended recipient.

6. The method of claim 1, wherein said method further comprises, in response to determining that a received email message contains said item of spain content, blocking a receipt of a future message from said source.

7. The method of claim 1, wherein said method further comprises, in response to determining that said received email message contains said item of virus content, performing a quarantine of said received email message.

8. A system for providing notice of nefarious remote control of a data processing system, said system comprising:
means for, in response to determining that a received email message contains an item of spam content, noting a source of said received email message to a harm database to increment a harm counter; and
means for, in response to determining that said harm counter has exceeded a harm threshold, notifying a designated administrator for said source.

9. The system of claim 8, wherein said system further comprises, in response to determining that said received email message contains an item of virus content;
means for noting said source of said received email message to said harm database to increment said harm counter;
means for performing a quarantine of said received email message;
means for sending a notice of a virus attack to a sender of said received email message; and
means for sending said notice of said virus attack to an intended recipient of said received email message.

10. The system of claim 8, wherein said system further comprises means for, in response to determining that said received email message contains said item of spam content, segregating said received email message.

11. The system of claim 8, wherein said system further comprises means for receiving said received email message.

12. The system of claim 8, wherein said system further comprises means for, in response to determining that said received email message does not contain said item of spam content and does not contain said item of virus content, delivering said message to an intended recipient.

13. The system of claim 8, wherein said system further comprises means for, in response to determining that a received email message contains said item of spam content, blocking a receipt of a future message from said source.

14. The system of claim 8, wherein said system further comprises means for, in response to determining that said received email message contains said item of virus content, performing a quarantine of said received email message.

15. A machine-readable medium having a plurality of instructions processable by a machine embodied therein, wherein said plurality of instructions, when processed by said machine, causes said machine to perform a method, said method comprising:
in response to determining that a received email message contains an item of spam content, noting a source of said received email message to a harm database to increment a harm counter; and
in response to determining that said harm counter has exceeded a harm threshold, notifying a designated administrator for said source.

16. The machine-readable medium of claim 15, wherein said method further comprises, in response to determining that said received email message contains an item of virus content;
noting said source of said received email message to said harm database to increment said harm counter;
performing a quarantine of said received email message;
sending a notice of a virus attack to a sender of said received email message; and
sending said notice of said virus attack to an intended recipient of said received email message.

17. The machine-readable medium of claim 15, wherein said method further comprises, in response to determining that said received email message contains said item of spam content, segregating said received email message.

18. The machine-readable medium of claim 15, wherein said method further comprises receiving said received email message.

19. The machine-readable medium of claim 15, wherein said method further comprises, in response to determining that said received email message does not contain said item of spam content and does not contain said item of virus content, delivering said message to an intended recipient.

20. The machine-readable medium of claim 15, wherein said method further comprises, in response to determining that a received email message contains said item of spam content, blocking a receipt of a future message from said source.
